(19) United States
(12) Patent Application Publication
(10) Pub. No.: US 2008/0283262 A1
(43) Pub. Date: Nov. 20, 2008

(54) Device and method for variable torque fastening

(75) Inventors: Jin Ho Kim, Suwon-si (KR); Wan Su Han, Hwaseong-si (KR); Gwang Hyun Back, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/149,171

(22) Filed: Apr. 28, 2008

(30) Foreign Application Priority Data
May 17, 2007 (KR) 10-2007-47962

(51) Int. Cl. B23Q 5/00

(52) U.S. Cl. 173/178

(57) ABSTRACT

A device and method for variable torque fastening are capable of easily varying a tightening torque and are capable of automatically changing a tightening torque according to the sequence set by an operator. The variable torque fastening device includes a fastening unit having a drive shaft which is rotated by a motor, a driven shaft which is rotated by the drive shaft and is mounted with a fastening tool, a slip clutch which intermittently connects the drive shaft to the driven shaft, and a piston which moves forward and backward by an air pressure to press the slip clutch, a compressed air supply source which supplies compressed air to the fastening unit to press the piston, and an air pressure control unit which controls a pressure of the air that presses the piston.

### CROSS-REFERENCE TO RELATED APPLICATIONS

This application claims the benefit of Korean Patent Application No. 2007-0047962, filed on May 17, 2007 in the Korean Intellectual Property Office, the disclosure of which is incorporated herein by reference.

### BACKGROUND

1. Field

The present invention relates to a device and method for variable torque fastening capable of varying a tightening torque of a screw.

2. Description of the Related Art

Electronic products such as televisions, refrigerators and air conditioners are manufactured by assembling a number of parts. In assembly of the product, a number of fixing screws are fastened to couple the parts to each other. Further, the screws fastened for assembly have different tightening forces with regard to fastening forces in respective portions. Accordingly, an electric variable torque fastening device capable of adjusting a tightening torque of a screw according to the demands of an operator is used in a general assembly production line.

In a general variable torque fastening device, for example, as disclosed in Korean Utility Model Publication No. 1990-5421, the user tightens or untightens an adjustment cap installed at a shaft to adjust elasticity of a torque spring disposed therein, thereby adjusting a tightening torque.

However, in the variable torque fastening device, since the user is required to manually adjust the torque whenever it is necessary, it is troublesome to adjust the torque. Accordingly, in the assembly production line, a plurality of fastening devices (e.g., electric drivers) having different torques are prepared to be alternately used. However, also in this method, since the user must change a fastening device in the assembly, the fastening device is inconvenient to use and assembly productivity is lowered. Further, since a plurality of fastening devices are used, an assembly error may occur due to operational confusion.

### SUMMARY

Embodiments of the present invention have been made in order to solve the above problems. It is an aspect of embodiments of the present invention to provide a device and method for variable torque fastening capable of easily varying a tightening torque.

It is another aspect of embodiments of the present invention to provide a device and method for variable torque fastening capable of automatically changing a tightening torque according to the sequence set by an operator.

Additional aspects and/or advantages will be set forth in part in the description which follows and, in part, will be apparent from the description, or may be learned by practice of the invention.

In accordance with an aspect of embodiments of the present invention, there is provided a variable torque fastening device including a fastening unit having a drive shaft which is rotated by a motor, a driven shaft which is rotated by the drive shaft, a slip clutch which intermittently connects the drive shaft to the driven shaft, and a piston which moves forward and backward by an air pressure to press the slip clutch, a compressed air supply source which supplies compressed air to the fastening unit to press the piston, and an air pressure control unit which controls a pressure of the air that presses the piston.

The driven shaft may be mounted with a fastening tool.

The pressure of air pressing the piston may correspond to a desired tightening torque to be applied to the driven shaft.

The slip clutch may slip to prevent a driven shaft from being rotated when a load larger than a desired torque is applied to the driven shaft.

In an embodiment, the fastening unit accommodates the piston moving forward and backward, and further includes a sealed room in which compressed air is introduced from one side thereof and a spring which is interposed between the piston and the slip clutch.

In an embodiment, the air pressure control unit includes a plurality of pressure regulators which are installed on air pipes in parallel, the air pipes connecting the compressed air supply source and the fastening unit, and a plurality of opening/closing valves which selectively open and close flow paths of air that has passed through the respective pressure regulators.

In an embodiment, the air pressure control unit further includes a controller which controls the opening/closing valves and an input unit which inputs an operation signal to the controller.

In an embodiment, the air pressure control unit includes a variable pressure regulator which is installed on an air pipe that connects the supply source and the fastening unit, an opening/closing valve which opens and closes a flow path of air that has passed through the variable pressure regulator, a controller which controls an operation of the variable pressure regulator according to set pressure control information, and an input unit which inputs an operation signal to the controller.

The set pressure control information may be a programmed sequence corresponding to a sequence of desired tightening torques.

The controller may restart from the beginning of the programmed sequence. The controller may advance through the programmed sequence according to the operational signal input into the controller.

In an embodiment, the motor is rotated by compressed air.

In an embodiment, the motor is an electric motor rotated by application of electric power.

In accordance with aspects of embodiments of the present invention, there is provided a method of variable torque fastening including adjusting a plurality of pressures corresponding with a plurality of pressure regulators, opening an opening/closing valve corresponding to one of the plurality of pressures, applying the one of the plurality of pressures to a sealed room of a fastening unit, pressing a spring with a piston transferring the applied pressure, and pressing a driven plate of a slip clutch with the spring.

The method may also include rotating a driven shaft with a tightening torque corresponding to the one of the plurality of pressures.

The method may also include slipping the slip clutch to prevent a driven shaft from being rotated.

In accordance with aspects of embodiments of the present invention, there is provided a method of variable torque fastening including programming into a controller a plurality of pressure control information in a desired sequence, controlling a pressure regulator according to the programmed pressure control information, applying a pressure created by the controlled pressure regulator to a sealed room of a fastening unit, pressing a spring with a piston transferring the applied pressure, and pressing a driven plate of a slip clutch with the spring.

The method may further include the controlling restarting from the beginning of the programmed pressure control information.

The method may further include comprising rotating a driven shaft with a tightening torque corresponding to the programmed pressure control information.

The method may further include slipping the slip clutch to prevent a driven shaft from being rotated.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a variable torque fastening device according to a first embodiment of the present invention; and

FIG. 2 illustrates a variable torque fastening device according to a second embodiment of the present invention.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Hereinafter, embodiments of the present invention will be described in detail with reference to the accompanying drawings.

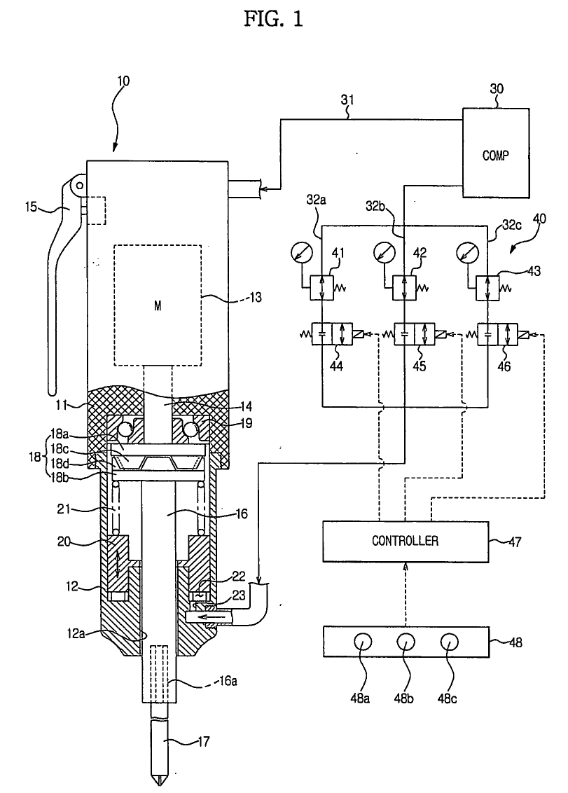

FIG. 1 illustrates a variable torque fastening device according to a first embodiment of the present invention. The variable torque fastening device includes a fastening unit 10 capable of fastening a bolt or screw, a compressed air supply source 30 which supplies compressed air for an operation of the fastening unit 10, and an air pressure control unit 40 which provides a controlled air pressure to the fastening unit 10 to control a tightening torque of the fastening unit 10.

The fastening unit 10 includes an upper housing 11 and a lower housing 12 which are coupled to each other. A pneumatic motor 13 which is rotated by an air pressure and a drive shaft 14 which is connected to the pneumatic motor 13 may be installed in the upper housing 11. Although not specifically shown in the drawings, the pneumatic motor 13 is rotated by compressed air supplied from the compressed air supply source 30 through an air pipe 31. That is, when a user operates an operation lever 15 installed on the outside of the upper housing 11, the pneumatic motor 13 is rotated while compressed air is supplied to the pneumatic motor 13. The compressed air supply source 30 may be a common air compressor which includes an air tank containing compressed air.

A driven shaft 16 having the same axis as the drive shaft 14 is installed in the lower housing 12. The driven shaft 16 is rotatably supported in a through hole 12a at the center of the lower housing 12. The driven shaft 16 has a connection groove 16a formed at a lower portion thereof, which is connected to a fastening tool 17 such as a driver bit. A slip clutch 18, which intermittently connects the drive shaft 14 with the driven shaft 16, is installed in an inner upper portion of the lower housing 12. The slip clutch 18 includes a drive plate 18a which is coupled to the drive shaft 14 and has a plurality of mountain-shaped engaging portions 18c, and a driven plate 18b which is coupled to the driven shaft 16 and has a plurality of mountain-shaped engaging portions 18d. That is, the mountain-shaped engaging portions 18c of the drive plate 18a are engaged with the mountain-shaped engaging portions 18d of the driven plate 18b. A reference numeral 19 denotes a bearing which rotatably supports the drive shaft 14 and the drive plate 18a.

Further, a cylindrical piston 20, which moves up and down within a specific range, is installed at the outside of the driven shaft 16 in the lower housing 12. A spring 21 is interposed between the piston 20 and the driven plate 18b. The piston 20 separates an inner lower space of the lower housing 12 from a space in which the spring 21 is installed, thereby forming a sealed room 22. The piston 20 is pressed upward by compressed air introduced into the sealed room 22. An air inlet 23 is formed below the sealed room 22 to introduce compressed air. Accordingly, when the piston 20 is pressed by the compressed air introduced into the sealed room 22, the piston 20 moves up to press the spring 21, and the spring 21 presses the driven plate 18b toward the drive plate 18a, thereby transferring a rotational force of the drive shaft 14 to the driven shaft 16. Further, if a load applied to the driven shaft 16 becomes larger than a preset torque, a slip of the driven plate 18b and the drive plate 18a occurs by the structure of the mountain-shaped engaging portions 18c and 18d, thereby cutting off the transfer of a driving force. In this case, the driven plate 18b is pushed toward the piston 20 against the elasticity of the spring 21 to cut off the transfer of the driving force, thereby adjusting the tightening torque.

The tightening torque of the fastening unit 10 is adjusted according to a force by which the piston 20 presses the spring 21. That is, the tightening torque is adjusted according to a force by which the piston 20 is pressed by the compressed air introduced into the sealed room 22 of the lower housing 12 from the compressed air supply source 30. The air pressure may be controlled by the air pressure control unit 40 to be described later.

The air pressure control unit 40 connects the compressed air supply source 30 to the air inlet 23 of the fastening unit 10. The air pressure control unit 40 may include first to third pressure regulators 41, 42 and 43 which are respectively installed on a plurality of air pipes 32a, 32b and 32c arranged in parallel lines, first to third opening/closing valves 44, 45 and 46 which are respectively installed at the outlet sides of the pressure regulators 41, 42 and 43, a controller 47 which controls the operation of the opening/closing valves 44, 45 and 46, and an input unit 48 which inputs an operation signal to the controller 47.

The first to third pressure regulators 41, 42 and 43 can control the pressure of the air supplied from the compressed air supply source 30 to be reduced to a desired pressure which is set by the user in advance. The first to third opening/closing valves 44, 45 and 46 may be electric opening/closing valves which open and close respective lines by control of the controller 47. The input unit 48 may include first to third switches 48a, 48b and 48c. According to this configuration, in case the user selectively operates the respective switches 48a, 48b and 48c of the input unit 48, the controller 47 selectively opens the first to third opening/closing valves 44, 45 and 46 based on the operation of the switches. That is, if the first switch 48a is operated, the first opening/closing valve 44 is opened, and if the second switch 48b is operated, the second opening/closing valve 45 is opened. If the third switch 48c is operated, the third opening/closing valve 46 is opened.

Next, an example of an operation of the variable torque fastening device and a method of using the variable torque fastening device will be described.

If screws are fastened with tightening torques 5 kgf·cm, 10 kgf·cm and 15 kgf·cm in the production line for a product assembly, an operator previously adjusts the set pressures of the first to third pressure regulators 41, 42 and 43 corresponding to the respective set torques. For example, the first pressure regulator 41 sets the pressure such that the fastening unit 10 provides a tightening torque of 5 kgf·cm. The second pressure regulator 42 sets the pressure such that the fastening unit 10 provides a tightening torque of 10 kgf·cm. The third pressure regulator 43 sets the pressure such that the fastening unit 10 provides a tightening torque of 15 kgf·cm.

Further, in case the operator fastens the screw with a tightening torque of 5 kgf·cm, the first opening/closing valve 44 is opened by operating the first switch 48a of the input unit 48, and the second and third opening/closing valves 45 and 46 are maintained in a closed state. In this case, an air pressure reduced by the first pressure regulator 41, which realizes a tightening torque of 5 kgf·cm, is applied to the sealed room 22 of the fastening unit 10. Accordingly, the piston 20 presses the spring 21 with this pressure, and the spring 21 presses the driven plate 18b of the slip clutch 18. Thus, when a fastening operation is performed in this state, a fixing screw is fastened with a tightening torque of 5 kgf·cm. If a load larger than the torque is applied to the driven shaft 16, a slip occurs in the slip clutch 18 such that the driven shaft 16 is not rotated.

Similarly, in case that the operator intends to perform a screw fastening operation with a tightening torque of 10 kgf·cm or 15 kgf·cm, the screw fastening operation is performed in the same way after operating the second switch 48b or the third switch 48c of the input unit 48. That is, if the second switch 48b is operated, only the second opening/closing valve 45 is opened to provide a pressure controlled by the second pressure regulator 42 to the sealed room 22 of the fastening unit 10. If the third switch 48c is operated, only the third opening/closing valve 46 is opened to provide a pressure controlled by the third pressure regulator 43 to the sealed room 22 of the fastening unit 10. Thus, the operator can easily change the tightening torque of the fastening unit 10 even during the screw fastening operation. That is, whenever the user selectively operates the switches 48a, 48b and 48c of the input unit, the pressure of the compressed air which is applied to the sealed room 22 of the fastening unit 10 can be easily changed to the selected pressure among the set pressures by the first to third pressure regulators 41, 42 and 43. Thus, it is possible to easily change the tightening torque of the fastening unit 10.

The input unit 48 provided to change the tightening torque may be arranged at a position capable of being easily operated by the operator. For example, the input unit 48 may be disposed on a table close to the operator, or may be attached to an outer surface of the fastening unit 10. Although the motor 13 of the fastening unit 10 has been described above as a pneumatic motor in FIG. 1, embodiments of the present invention may also include the fastening unit 10 employing an electric motor which is rotated by application of electric power without being limited thereto.

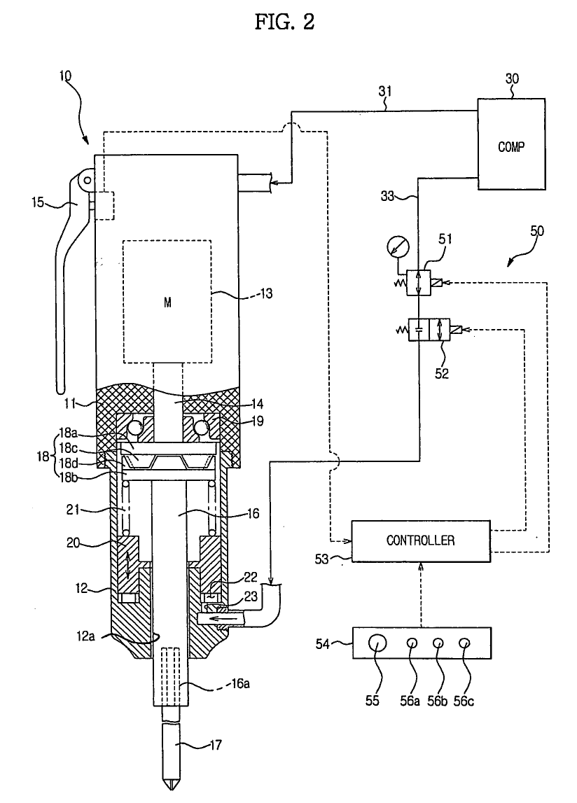

FIG. 2 illustrates a variable torque fastening device according to a second embodiment of the present invention. The fastening unit of the second embodiment is the same as that of the first embodiment, and the air pressure control unit of the second embodiment is different from that of the first embodiment. In FIG. 2, parts having the same configuration as those of FIG. 1 are designated by the same reference numerals.

An air pressure control unit 50 of the second embodiment includes a variable pressure regulator 51 which is installed on an air pipe 33 that connects the compressed air supply source 30 and the fastening unit 10, an opening/closing valve 52 which opens and closes a flow path of air that has passed through the variable pressure regulator 51, a controller 53 which controls the operations of the variable pressure regulator 51 and the opening/closing valve 52 according to the set pressure control information, and an input unit 54 which inputs an operation signal to the controller 53.

Since the variable pressure regulator 51 includes its own driving device, the variable pressure regulator 51 can control an air pressure applied to the fastening unit 10 while being operated by control of the controller 53. Further, the controller 53 stores pressure control information (information inputted by the user) to control the pressure regulator 51. The controller 53 controls the variable pressure regulator 51 such that the air pressure applied to the fastening unit 10 is regulated sequentially by a program according to the stored pressure control information. The opening/closing valve 52 opens the flow path when the fastening unit 10 is operated. For this, an operation signal of the operation lever 15 of the fastening unit 10 is transferred to the controller 53. Thus, the operation signal may be used by the controller to advance through the programmed pressure control information sequence.

The pressure control information stored in the controller 53 can be set by the user through the operation of the input unit 54. For this, the input unit 54 includes a plurality of input switches 56a, 56b and 56c and an initialization switch 55 which initializes the operation.

An example of the operation of the variable torque fastening device and the method of using the variable torque fastening device according to the second embodiment of the present invention are explained below.

For example, in case that the operator intends to perform a screw fastening operation while sequentially varying the tightening torques of 5 kgf·cm, 10 kgf·cm and 15 kgf·cm, the pressure control information is inputted into the controller 53 in advance such that the tightening torque can be sequentially changed by operating the input switches 56a, 56b and 56c.

When the fastening operation is performed in this state, a first screw is fastened with a tightening torque of 5 kgf·cm, and a second screw is fastened with a tightening torque of 10 kgf·cm. Then, a third screw is fastened with a tightening torque of 15 kgf·cm. In this case, the controller 53 controls the pressure regulator 51 according to the pressure control information such that the tightening torque is automatically changed. The controller may advance through the pressure control information sequence based on an operation signal input into the controller 53. As an example, such an operation signal may be generated by the operation lever 15. After the screws are fastened in the preset order, the screw is fastened with a first tightening torque, i.e., 5 kgf·cm, again. If the user intends to restart the operation (from a tightening torque of 5 kgf·cm), the user may push the initialization switch 55. In this case, the fastening operation is performed in the preset order again.

As described above, in the variable torque fastening device according to the present invention, the air pressure applied to the fastening unit 10 is changed to vary the tightening torque of the fastening unit 10 only by operating the switches 55, 56a, 56b, 56c of the input unit. Accordingly, the operator can easily change the tightening torque to a desired value, thereby improving assembly productivity.

Further, according to embodiments of the present invention, the tightening torque is automatically controlled while the air pressure applied to the fastening unit is sequentially changed according to the preset program (pressure control information). Thus, there is an effect of easily performing the screw fastening operation or the like in the preset order without changing the tightening torque during the operation.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A variable torque fastening device comprising:
a fastening unit comprising:
a drive shaft rotated by a motor;
a driven shaft rotated by the drive shaft;
a slip clutch intermittently connecting the drive shaft to the driven shaft; and
a piston moving forward and backward by an air pressure to press the slip clutch;
a compressed air supply source which supplies compressed air to the fastening unit to press the piston; and
an air pressure control unit which controls a pressure of the air that presses the piston.

2. The variable torque fastening device according to claim 1, wherein the driven shaft is mounted with a fastening tool.

3. The variable torque fastening device according to claim 1, wherein the pressure of air pressing the piston corresponds to a desired tightening torque to be applied to the driven shaft.

4. The variable torque fastening device according to claim 1, wherein the fastening unit accommodates the piston moving forward and backward, and further comprises:
a sealed room in which compressed air is introduced from one side thereof; and
a spring which is interposed between the piston and the slip clutch.

5. The variable torque fastening device according to claim 1, wherein the air pressure control unit comprises:
a plurality of pressure regulators which are installed on air pipes in parallel, the air pipes connecting the compressed air supply source and the fastening unit; and
a plurality of opening/closing valves which selectively open and close flow paths of air that has passed through the respective plurality of pressure regulators.

6. The variable torque fastening device according to claim 5, wherein the air pressure control unit further comprises:
a controller which controls the plurality of opening/closing valves; and
an input unit which inputs an operation signal to the controller.

7. The variable torque fastening device according to claim 1; wherein the air pressure control unit comprises:
a variable pressure regulator which is installed on an air pipe that connects the supply source and the fastening unit;
an opening/closing valve which opens and closes a flow path of air that has passed through the variable pressure regulator;
a controller which controls an operation of the variable pressure regulator according to set pressure control information; and
an input unit which inputs an operation signal to the controller.

8. The variable torque fastening device according to claim 7, wherein the set pressure control information is a programmed sequence corresponding to a sequence of desired tightening torques.

9. The variable torque fastening device according to claim 7, wherein the controller may restart from the beginning of the programmed sequence.

10. The variable torque fastening device according to claim 1, wherein the motor is rotated by compressed air.

11. The variable torque fastening device according to claim 1, wherein the motor is an electric motor which is rotated by application of electric power.

12. The variable torque fastening device according to claim 1, wherein the slip clutch slips to prevent a driven shaft from being rotated when a load larger than a desired torque is applied to the driven shaft.

13. A method of variable torque fastening comprising:
adjusting a plurality of pressures corresponding with a plurality of pressure regulators;
opening an opening/closing valve corresponding to one of the plurality of pressures;
applying the one of the plurality of pressures to a sealed room of a fastening unit;
pressing a spring with a piston transferring the applied pressure; and
pressing a driven plate of a slip clutch with the spring.

14. The method according to claim 13 further comprising rotating a driven shaft with a tightening torque corresponding to the one of the plurality of pressures.

15. The method according to claim 13 further comprising slipping the slip clutch to prevent a driven shaft from being rotated.

16. A method of variable torque fastening comprising:
programming into a controller a plurality of pressure control information in a desired sequence;
controlling a pressure regulator according to the programmed pressure control information;
applying a pressure created by the controlled pressure regulator to a sealed room of a fastening unit;
pressing a spring with a piston transferring the applied pressure; and
pressing a driven plate of a slip clutch with the spring.

17. The method according to claim 16 wherein the controlling may restart from the beginning of the programmed pressure control information.

18. The method according to claim 16 further comprising rotating a driven shaft with a tightening torque corresponding to the programmed pressure control information.

19. The method according to claim 16 further comprising slipping the slip clutch to prevent a driven shaft from being rotated.

20. A variable torque fastening device comprising:
a drive shaft rotated by a motor;
a driven shaft rotated by the drive shaft;
a slip clutch intermittently connecting the drive shaft to the driven shaft;
a compressed air supply source supplying pressurized air;
an air pressure control unit controlling the pressurized air; and
a piston moved by the controlled pressurized air to press the slip clutch.

21. The variable torque fastening device according to claim 20, wherein the controlled pressurized air moving the piston corresponds to a desired tightening torque to be applied to the driven shaft.

22. The variable torque fastening device according to claim 20, wherein the air pressure control unit controls the pressurized air according to a programmed sequence of pressure control information corresponding with a desired sequence of tightening torques to be applied to the driven shaft.

23. The variable torque fastening device according to claim 22, wherein the programmed sequence of pressure control information advances according to an operation signal.
